(19) United States
(12) Patent Application Publication
(10) Pub. No.: US 2002/0124727 A1
(43) Pub. Date: Sep. 12, 2002

(54) Method and device for regenerating an adsorber

(76) Inventor: Gunther Hauck, Berlin (DE)

Correspondence Address: CROWELL & MORING L.L.P., P.O. Box 14300, Washington, DC, 20044-4300, US

(21) Appl. No.: 10/034,214

(22) Filed: Jan. 3, 2002

(30) Foreign Application Priority Data
Jan. 3, 2001 (DE) 101 00 114.2

(51) Int. Cl. B01D 53/02

(52) U.S. Cl. 95/148; 96/146

(57) ABSTRACT

A method for regenerating a loaded adsorber includes heating a regenerating gas flow by a hot thermal oil flow and directing the heated regenerating gas flow through the loaded adsorber.

This application claims the priority of German patent document DE 101 00 114.2, filed Jan. 3, 2001, the disclosure of which is expressly incorporated by reference herein.

### BACKGROUND AND SUMMARY OF INVENTION

The present invention relates to a method as well as a device for regenerating a loaded adsorber by a heated regenerating gas flow.

For purifying or separating a gas mixture of at least two components by an adsorption process two different types of methods can be realized in principle, namely, (1) temperature swing adsorption processes or (2) pressure swing adsorption processes. In the pressure swing adsorption processes, the adsorption is carried out under a pressure p, while the desorption and regeneration of a loaded adsorber is carried out at a pressure of <p.

In a temperature swing adsorption process, the adsorption takes place at a temperature T₁, while the regeneration of a loaded adsorber is carried out at a temperature of >T. In the thermal regeneration, the pollutants retained in the adsorption cycle of the adsorber or adsorption agent are desorbed again by introducing a regenerating gas at a temperature T₂ via the adsorber, which is higher than the temperature T₁ in the adsorption cycle. The temperature difference T₂−T₁ amounts to at least 30 K and ranges, for example, from 30 to 250 K, preferably 80 to 180 K. The usual adsorption temperatures are at 5 to 35° C., preferably at 7 to 20° C.

These methods are also used, for example, for the purification of the process air used for a cryogenic air separation, wherein atmospheric air is compressed and fed to the purification process. The purified air is then cooled and fed at least in part to a rectification column. As a rule, at least one pair of reversible adsorbers is provided, which can be alternately loaded (adsorption cycle) and desorbed (regeneration cycle) such as the one known, for example, from German patent publication DE-A 20 64 137 (U.S. Pat. No. 3,808,773).

The adsorption pair, which is alternately regenerated at 80 to 250° C. for prepurifying the air before the cold part of a rectifying air separation, has represented for a long time a well-known and applied technology. Therein, mainly water and carbon dioxide is separated from the compressed process airflow, as well as other hydrocarbons and acetylene (C₂H₂), which represent a high danger potential in liquid oxygen (LOX).

As soon as they are loaded, the adsorbers used for the prepurification process are regenerated by the residual gas flow extracted from the air separation system. This residual gas flow is present at the outlet of the main heat exchanger with approximately 20° C. Therefore, it is first heated during the regeneration cycle to a temperature of 180 to 220° C. and then conducted via the loaded adsorber. The heating of the previously mentioned regenerating gas flow had taken place until now as a rule by an electric heater. This type of method will be explained in more detail with reference to the embodiment shown in FIG. 1.

FIG. 1 shows an adsorber pair A and A′, to which via line 1 the compressed process air flow, which is to be purified, is fed. While one of the adsorbers is in the adsorption cycle, the other adsorber or the adsorption agent located therein is desorbed or regenerated. The process air released from the previously mentioned adsorbing components is extracted via line 2 from the adsorbers A and A′ and is supplied to a cryogenic air separating system 12.

In the embodiment shown in FIG. 1 as well as also in the exemplary embodiments shown in FIGS. 2 to 5 the required (control) valves, flaps, and the like, whose arrangement is known to an expert, have been eliminated.

A residual gas flow, which occurs in the cryogenic air separating system, is removed from the air separating system via line 3. At least one partial flow of this residual gas flow is branched off via line 4, conducted via lines 5 and 6 to an electric heater E, and heated therein to the desired regeneration temperature, for example, 180 to 220° C. The regenerating gas flow heated in this manner is then conducted via line 8 to the adsorber, which as a rule is in the regeneration cycle. After flowing through the loaded adsorber, which is to be regenerated, the regenerating gas flow loaded with the desorbed components leaves the adsorber via line 9.

As a rule, during the regeneration cycle, the heating of the loaded adsorber by the hot regenerating gas flow is followed by a cooling step. Therein, the residual gas flow flows at a temperature of approximately 20° C. through the adsorber to be regenerated. As a consequence thereof, the temperature profile built up in the adsorption agent accumulation is pushed through the adsorption agent accumulation. The cooling step is ended when in the entire adsorption agent accumulation a temperature exists that is close to the temperature of the residual gas flow.

Such a cooling step prevents the hot process air from being conducted via line 2 to the cryogenic air separating system after reversing the adsorber, which would cause considerable disadvantages. A heating of the residual gas flow is not required during the cooling step. To reduce the connected load of the electric heater E, a heat accumulator B can be loaded during this time. For this purpose, additional residual gas, which is conducted through the heat accumulator B, is heated and removed via a line 7′. As soon as heated residual gas is needed again, a partial flow of the residual gas flow is fed through the electric heater E and a partial flow is fed through the heat accumulator B.

As soon as the regeneration of a loaded adsorber is completed, the adsorbers are reversed. This means that now that adsorber, which was before in the adsorption cycle, is regenerated, while the previously regenerated adsorber is switched into the adsorption cycle.

As an alternative to the heating of the regenerating gas flow by means of the electric heater E shown in FIG. 1, steam—insofar as it is available and within the corresponding pressure range—can also be used. The operation of a steam system is, however, complex in comparison.

It is an object of the present invention to define a method as well as a device for regenerating a loaded adsorber by a heated regenerating gas flow, which is or are more economic or easier to operate with respect to the state of the art.

According to the present invention a thermal oil system is provided, in which a hot thermal oil flow is produced by combustion of fossil fuels and/or suitable residual substances and/or by using suitable waste heat, which functioning as heat transfer medium—heats the regenerating gas flow.

The device in accordance with the present invention for regenerating a loaded adsorber by a heated regenerating gas flow comprises:

one or several adsorbers arranged in parallel and/or in series,

at least one regenerating gas line connected to the adsorber or adsorbers,

a thermal oil system in which a hot, if necessary circulating, thermal oil flow is produced by the combustion of a suitable medium, and

at least one heat exchanger, in which heat contact takes place between the regenerating gas flow that is supposed to be heated and the thermal oil flow.

The present invention makes it possible to realize the heating of the regenerating gas flow with considerably less expense than when using an electric heater. Another advantage of the present invention consists of the fact that the regenerating gas flow/thermal oil heat exchanger has a pressure loss of merely approximately 2.5 mbar. By contrast, a heat accumulator generates a pressure loss of about 50 mbar, including the pressure losses caused by flaps, pipelines, and the like.

This results in the additional advantage that the regenerating gas flow can be under a lower pressure, which in the case of the cryogenic air separation causes the process airflow to be compressed less. This results in considerable savings with respect to compression costs.

Other objects, advantages and novel features of the present invention will become apparent from the following detailed description of the invention when considered in conjunction with the accompanying drawings.

### BRIEF DESCRIPTION OF THE DRAWINGS

FIG. 1 shows an adsorber system using an electric heater;

FIG. 2 shows an adsorber system according to the present invention with a thermal oil system;

FIG. 3 shows an embodiment of an adsorber system according to the present invention;

FIG. 4 shows an adsorber system according to the present invention; and

FIG. 5 shows an adsorber system according to the present invention.

### DETAILED DESCRIPTION OF THE DRAWINGS

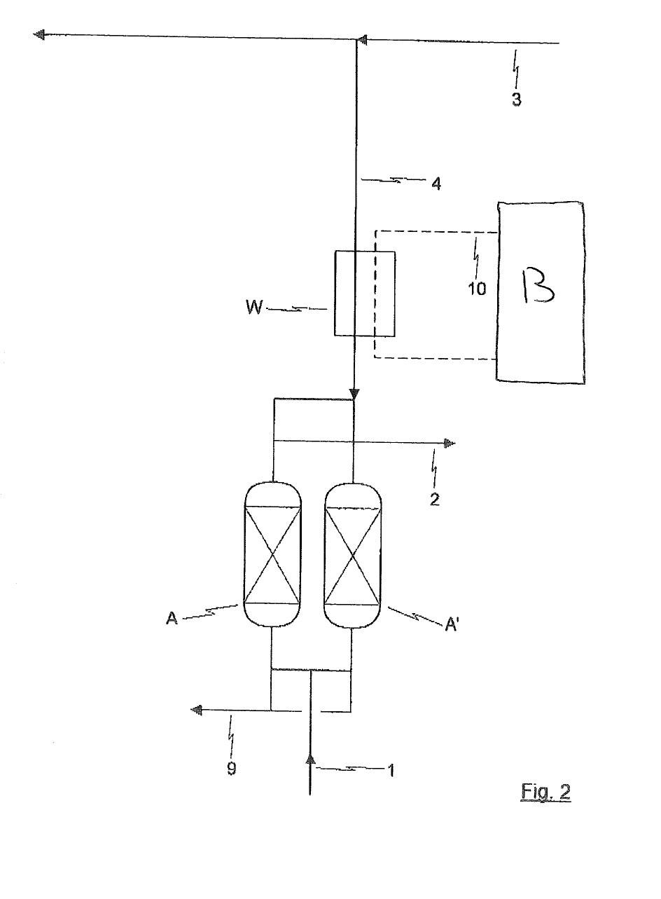

In the embodiment of the present invention shown in FIG. 2, a heat exchanger W is arranged in the line 4, in which at least one partial flow of the residual gas is extracted and conducted to the adsorbers for the purpose of regeneration. Via the line 10, which is shown dotted, a thermal oil flow, which is produced by the thermal oil system 13, is guided through the heat exchanger W and heats the regenerating gas flow conducted in the line 4.

If no heating of the regenerating gas flow is desired in the line 4, then the thermal oil flow in the line 10 must be either interrupted or a bypass line—which is not shown in FIGS. 2 to 5—which circumvents the heat exchanger W must be provided.

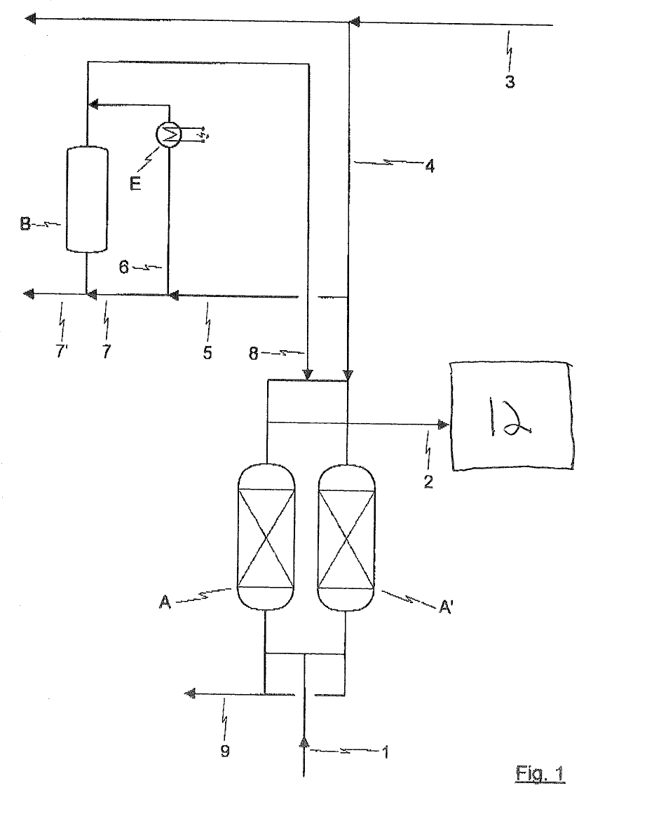

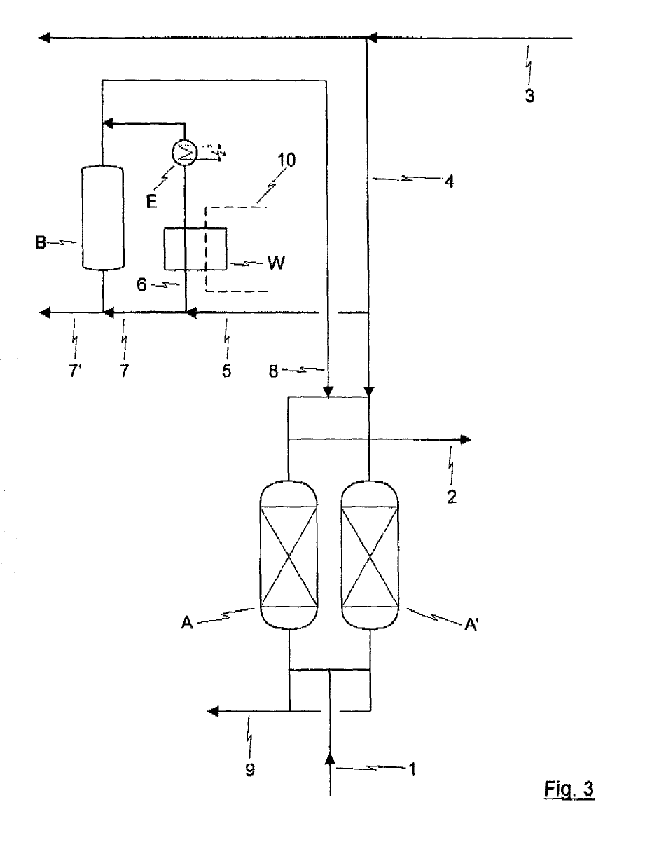

FIG. 3 shows an exemplary embodiment, which differs from the exemplary embodiment shown in FIG. 1 only in that the heat exchanger W is connected ahead of the electric heater E. The heat exchanger W could also be connected thereafter. The regenerating gas flow to be heated in the line 5 can now be heated to the desired regenerating temperature either via the hot thermal oil flow circulating in the line 10, by the electric heater E, or by a combination of the thermal oil flow and an electric heater.

The type of method shown in FIG. 3 is particularly suitable when retrofitting already existing plants, wherein the heating of the regenerating gas flow takes place via an electric heater, since the mode of operation, especially the programming of the plant controls, does not have to be modified.

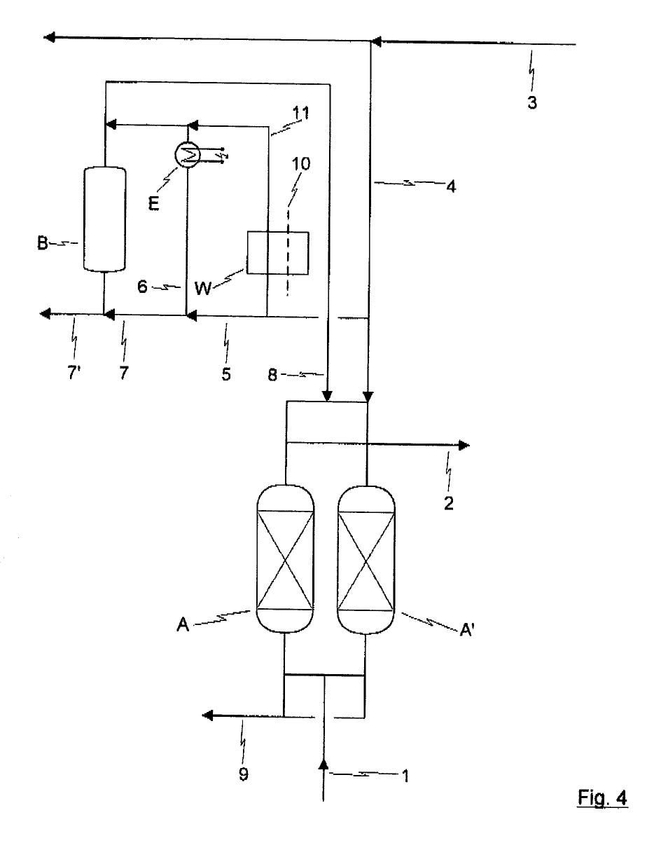

FIG. 4 shows another possible type of method, wherein the heat exchanger W is arranged in a line 11 provided parallel to the already described line 6. This type of method is particularly practical when the electric heater E and the heat accumulator B should remain available as so-called backups, but when during normal operation the entire regenerating gas quantity to be heated is conducted through the heat exchanger W. In this way, the required residual gas pressure is lowered. During normal operation, a small partial flow of the heated residual gas flow is conducted through the heat accumulator B, so that it is ensured that the heat accumulator B can be maintained at a sufficiently high operating and processing temperature.

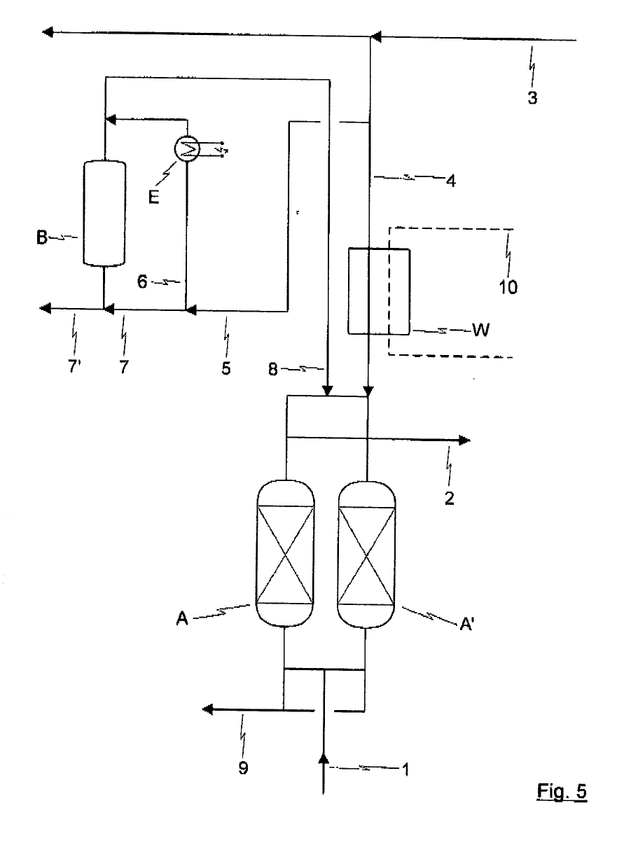

The type of method shown in FIG. 5, which is simplified with respect to the method of FIG. 4, has the advantage that the required piping is less complicated. This is counteracted by the disadvantage of a slightly higher pressure drop during the cooling step.

The method in accordance with the present invention as well as the device in accordance with the present invention for regenerating a loaded adsorber by means of a heated regenerating gas flow enables a clear reduction of the energy required for the heating of the regenerating gas flow. These systems are also easier to operate than the systems wherein steam is used to heat the regenerating gas flow.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for regenerating a loaded adsorber, comprising:
heating a regenerating gas flow by heat exchange with a hot thermal oil flow; and
directing the heated regenerating gas flow through the loaded adsorber.

2. A method according to claim 1, further comprising at least one of additionally heating the regenerating gas flow or at least in part alternately heating the regenerating gas flow by an electric heater.

3. A method according to claim 1, wherein the thermal oil flow is produced in a thermal oil system, which is fueled with at least one of natural gas, crude oil, blast furnace gas, coke oven gas, or solid fuels.

4. A method according to claim 1, wherein the thermal oil flow is produced in a thermal oil system that is heated at least partially by waste heat.

5. A method according to claim 1, wherein the loaded adsorber to be regenerated separates pollutants from an air flow being fed to a cryogenic air separating system, wherein at least one partial flow or one of the residual gas flows occurring in the cryogenic air separating system is used as regenerating gas flow.

6. A method according to claim 5, wherein the pollutants are water and carbon dioxide.

7. A device for regenerating a loaded adsorber by a heated regenerating gas flow, comprising:
one or more adsorbers arranged in parallel and/or in series;
at least one generating gas line connected to the one or more adsorbers;
a thermal oil system in which a hot thermal oil flow is produced by the combustion of a medium; and
at least one heat exchanger in which heat exchange occurs between the regenerating gas flow to be heated and the thermal oil flow.

8. A device according to claim 7, wherein the thermal oil flow is a circulating oil flow.

9. A device according to claim 7, further comprising an electric heater connected ahead, after, and/or in parallel to the heat exchanger in the regenerating gas lines.
